(19) United States
(12) Patent Application Publication
(10) Pub. No.: US 2015/0241809 A1
(43) Pub. Date: Aug. 27, 2015

(54) CONDUCTIVE ROLL AND METHOD FOR MANUFACTURING THE SAME

(71) Applicant: SUMITOMO RIKO COMPANY LIMITED, Komaki-shi (JP)

(72) Inventors: Naoaki Sasakibara, Shizuoka (JP); Hiroshi Ukai, Shizuoka (JP); Kadai Takeyama, Shizuoka (JP)

(73) Assignee: SUMITOMO RIKO COMPANY LIMITED, Komaki-shi (JP)

(21) Appl. No.: 14/707,635

(22) Filed: May 8, 2015

Related U.S. Application Data
(63) Continuation of application No. PCT/JP2014/075434, filed on Sep. 25, 2014.

(30) Foreign Application Priority Data
Sep. 26, 2013 (JP) 2013-199866

(51) Int. Cl. G03G 15/02; B32B 37/12

(52) U.S. Cl. CPC G03G 15/0233; B32B 37/12; B32B 2305/72; B32B 2361/00; B32B 2309/105; B32B 2309/02

(57) ABSTRACT

A phenol resin adhesive is applied to the outer peripheral surface of an axis body 2 and heated for baking to thereby form a undercoating layer 31. A phenol resin adhesive is further applied to the outer peripheral surface of the undercoating layer 31 to thereby form an upper coating layer 32. A rubber elastic layer-forming unvulcanized material for forming a rubber elastic layer 4 is laminated on the outer peripheral surface of the upper coating layer 32, and the rubber elastic layer forming material is vulcanized by heating to thereby form the rubber elastic layer 4, wherein the rubber elastic layer 4 and the undercoating layer 31 are adhered through the upper coating layer 32 while heated and vulcanized.

### TECHNICAL FIELD

The present invention relates to a conductive roll, and a method for manufacturing the conductive roll.

### BACKGROUND ART

Conductive rolls have been conventionally used in various fields. For example, in the fields of image forming devices, such as copying machines, printers and facsimile machines, employing an electrophotographic system, there are used conductive rolls having an axis body, an adhesive layer formed on the outer peripheral surface of the axis body, and a rubber elastic layer formed on the outer peripheral surface of the adhesive layer. There are cases where the conductive roll further has a surface layer on the outer peripheral surface of the rubber elastic layer, and also cases where the surface of the rubber elastic layer is subjected to a surface treatment.

Patent Literature 1 discloses a method for manufacturing a conductive roll in which an epoxy adhesive agent is applied to the outer peripheral surface of a conductive axis body, dried and baked to thereby form an adhesive layer, and thereafter, a base rubber layer is formed on the outer periphery of the axis body having the adhesive layer formed thereon by a crosslinking reaction.

### PRIOR ART DOCUMENTS

### Patent Literature

Patent Literature 1: JP-A-2004-270839

### SUMMARY OF THE INVENTION

### Problems to be Solved by the Invention

However, conventional technologies have a problem in the following point. That is, a metallic axis body, an adhesive agent and a rubber elastic layer usually are different in optimum adhesion temperature. Therefore, temperature control is very severe when the rubber elastic layer is formed on the axis body through the adhesive agent; if the temperature condition deviates, peeling-off of the adhesive agent occurs to cause surface waviness on a conductive roll obtained, which results in the poor appearance. Further if peeling-off of the adhesive agent occurs in use of the conductive roll, image deficiency and the like occurs and its function cannot be sufficiently exhibited.

The present invention has been made in light of such background, and provides a conductive roll improved in adhesion between an axis body and a rubber elastic layer.

### Solutions to the Problems

One aspect of the present invention provides a method for manufacturing a conductive roll for use in an electrophotographic image forming device, which includes an axis body with a surface formed of metal, an adhesive layer formed on an outer peripheral surface of the axis body, and a rubber elastic layer with conductivity formed on an outer peripheral surface of the adhesive layer. The method includes:

an undercoating layer forming step of applying a phenol resin adhesive to the outer peripheral surface of the axis body and baking the phenol resin adhesive by heating to thereby form an undercoating layer;

an upper coating layer forming step of further applying the phenol resin adhesive to an outer peripheral surface of the undercoating layer formed in the precedent step to thereby form an upper coating layer; and

a rubber elastic layer forming step of laminating a rubber elastic layer-forming unvulcanized material for forming the rubber elastic layer, on an outer peripheral surface of the upper coating layer formed in the precedent step and vulcanizing the rubber elastic layer-forming material by heating to thereby form the rubber elastic layer, wherein the rubber elastic layer and the undercoating layer are adhered through the upper coating layer while heated and vulcanized

Another aspect of the present invention provides a conductive roll obtained by the aforesaid method for manufacturing a conductive roll.

### Effects of the Invention

The aforesaid method for manufacturing a conductive roll includes the undercoating layer forming step. In this step, a phenol resin adhesive applied to the outer peripheral surface of an axis body is heated and cured to thereby form a undercoating layer firmly adhered on the axis body. The method for manufacturing a conductive roll includes the upper coating layer forming step. In this step, an uncured upper coating layer is formed on the undercoating layer firmly adhered on the axis body. The method for manufacturing a conductive roll includes the rubber elastic layer forming step. In this step, the uncured upper coating layer is cured by heat of a rubber elastic layer-forming material during heat vulcanization, and the rubber elastic layer formed thereby and the undercoating layer are adhered through the upper coating layer during the vulcanization. Further, in the method for manufacturing a conductive roll, because the adhesive layer is composed of the upper coating layer and the undercoating layer, the adhesion between the axis body and the adhesive layer, and the adhesion of the adhesive layer and the rubber elastic layer can be performed respectively at optimum adhesion temperatures. Consequently, according to the method for manufacturing a conductive roll, there can be provided a conductive roll improved in adhesion between the axis body and the rubber elastic layer.

Further, in the method for manufacturing a conductive roll, since the optimum adhesion temperatures can be set as described above, a high adhesion can be secured even if the thickness of an adhesive layer is relatively small. Further, in the method for manufacturing a conductive roll, since an adhesive layer can be formed in a comparatively small thickness, it also has an advantage of reduction in the amount of an adhesive agent to be used.

The mechanism to realize a conductive roll improved in adhesion between an axis body and a rubber elastic layer as described above is presumed as follows.

Specifically, in the undercoating layer forming step, hydroxyl groups present on the surface of an axis body and hydroxyl groups originated from phenol groups and the like contained in a phenol resin adhesive are bonded through hydrogen bonds, and hydroxyl groups in the phenol resin adhesive which have not been consumed by the hydrogen bonds perform condensation reaction, to thereby form a undercoating layer of a phenol resin on the axis body. Then, an uncured upper coating layer is applied to the cured undercoating layer, and a rubber elastic layer-forming material laminated on the outer peripheral surface of the upper coating layer is vulcanized by heating, so that a rubber elastic layer is formed and the upper coating layer is cured by heat in the heat vulcanization. In this case, the undercoating layer and the upper coating layer are composed of the same phenol resin adhesive. Therefore, counter diffusion occurs between the undercoating layer and the upper coating layer, which allows the aforesaid two layers to be compatible with each other to ensure close contact therebetween. And also hydrogen bonds are produced between hydroxyl groups contained in each of the both layers. In this way, the undercoating layer and the upper coating layer are firmly adhered with a sufficient adhesive force. On the other hand, during vulcanization, the phenol resin adhesive forming the upper coating layer and a rubber component in the rubber elastic layer are chemically bonded (crosslinking). And also counter diffusion occurs between the upper coating layer and the rubber elastic layer. Hence, the upper coating layer and the rubber elastic layer are closely contacted with each other. In this way, the upper coating layer and the rubber elastic layer are firmly adhered while heated and vulcanized. It is conceivable from the above that in the conductive roll obtained by the method for manufacturing a conductive roll, the adhesive force can be improved to such a degree that when the rubber elastic layer is attempted to be forcibly peeled off from the axis body for evaluation of adhesivity, peeling-off does not occur either between the axis body and the adhesive layer or between the adhesive layer and the rubber elastic layer, but failure occurs in the rubber elastic layer.

### BRIEF DESCRIPTION OF THE DRAWINGS

FIG. 1 is a perspective view schematically illustrating an outline configuration of a conductive roll manufactured by a method for manufacturing a conductive roll of Example 1.

FIG. 2 is a II-II cross-sectional view in FIG. 1.

FIGS. 3a-3c are explanatory view schematically illustrating each step of the method for manufacturing a conductive roll of Example 1.

### MODE FOR CARRYING OUT THE INVENTION

The aforesaid method for manufacturing a conductive roll will be described. The method is a method for manufacturing a conductive roll including an axis body with a surface formed of metal, an adhesive layer formed on the outer peripheral surface of the axis body, and a rubber elastic layer with conductivity formed on the outer peripheral surface of the adhesive layer.

The aforesaid conductive roll can specifically be applied to a charging roll, a developing roll or the like incorporated in an image forming device of an electrophotographic system, such as a copying machine, a printer, a facsimile machine, a multifunction printer or a POD (Print On Demand) device employing an electrophotographic system.

In the method for manufacturing a conductive roll, the undercoating layer forming step is a step of applying a phenol resin adhesive to the outer peripheral surface of an axis body and baking the adhesive agent by heating to thereby form a undercoating layer.

As the axis body, there can be used an axis body at least the surface of which is formed of metal (including an alloy), and which is formed long in the axis direction in a predetermined diameter. Specific examples of the axis body include solid bodies (core metals) and hollow bodies made of a metal (including an alloy) such as stainless steel, aluminum or iron, and solid bodies and hollow bodies made of a plastic and having plated metal formed thereon. The diameter of an axis body can be made to be about 4 to 10 mm.

The phenol resin adhesive is a resin adhesive that can be cured by heat to thereby form a phenol resin. As the phenol resin adhesive, a novolac-type phenol resin adhesive and/or a resol-type phenol resin adhesive can be used. The novolac-type phenol resin adhesive is cured by heat to form a novolac-type phenol resin. The resol-type phenol resin adhesive is cured by heat to form a resol-type phenol resin. A phenol resin adhesive containing the novolac-type and the resol-type phenol resin adhesive is cured by heat to form a phenol resin containing both structures of a novolac-type and a resol-type.

In the case where the phenol resin adhesive is a novolac-type phenol resin adhesive and/or a resol-type phenol resin adhesive, by regulating the ratio of its novolac-type structure and its resol-type structure, the adhesivity to the surface of the axis body and the adhesivity to a rubber elastic layer are made to be easily regulated and a conductive roll excellent in adhesion between the axis body and the rubber elastic layer is made to be easily obtained. In the case where the ratio of the resol-type structure is relatively high, the adhesivity to the surface of the axis body is made to be easily improved. By contrast, in the case where the ratio of the resol-type structure is relatively low, the adhesivity to the rubber elastic layer is made to be easily improved. As the phenol resin adhesive, a novolac-type and resol-type phenol resin adhesive can especially suitably be used from the viewpoint of more reliable regulation.

As the phenol resin adhesive, specifically, there can be used a liquid composition containing at least one of monomer and oligomer components to form a novolac-type phenol resin and/or a resol-type phenol resin, and an organic solvent such as methyl ethyl ketone. The liquid composition can additionally contain a curing agent such as hexamethylenetetramine. Here, the phenol resin adhesive may have a conductivity, for example, by incorporating a conductive agent, or may have no conductivity.

The aforesaid application of the phenol resin adhesive can be carried out by spraying, immersion, brush coating or the like. Further the application is carried out so that the phenol resin adhesive is not adhered within the ranges of a certain distance from both ends of an axis body toward the central part of the axis. This is to form a rubber elastic layer in a roll form along the outer peripheral surface of the axis body in the state of both ends of the axis body being protruded. Here, the phenol resin adhesive applied to the axis body, before being heated, can be dried, for example by natural drying or drying means such as hot air.

In the aforesaid baking, from the viewpoint of improvement of the baking property of a undercoating layer to the axis body, the thermal deterioration and the like, the heating temperature can be made to be, for example, about 140° C. to 220° C., and preferably about 150° C. to 220° C.; and the heating time can be made to be, for example, about 1 min to 30 min, and preferably about 5 min to 15 min. The thickness of the undercoating layer to be formed, from the viewpoint of securing the adhesive force, reduction of the amount of the adhesive agent to be used, manufacturing cost, conductivity and the like, can be made to be about 0.1 μm to 10 μm, and preferably about 1 μm to 5 μm.

In the method for manufacturing a conductive roll, the upper coating layer forming step is a step of further applying the phenol resin adhesive to the outer peripheral surface of the undercoating layer formed in the precedent step to thereby form an upper coating layer.

The phenol resin adhesive to be further applied in this step is preferably the same phenol resin adhesive as used in the aforesaid undercoating layer forming step. This is advantageous for the improvement of the adhesivity between the axis body and the rubber elastic layer since the adhesivity between the undercoating layer and the upper coating layer is excellent. This also has advantages including excellent productivity since the kinds of phenol resin adhesives to be used in manufacturing a conductive roll can be reduced.

The thickness of the upper coating layer to be formed, from the viewpoint of securing the adhesive force, reduction of the amount of the adhesive agent to be used, manufacturing cost, conductivity and the like, can be made to be about 0.1 μm to 10 μm, and preferably about 1 μm to 7 μm. Here, the aforesaid application can be carried out in the same manner as in the undercoating layer.

In the method for manufacturing a conductive roll, a rubber elastic layer forming step is a step of laminating a rubber elastic layer-forming unvulcanized material for forming a rubber elastic layer, on the outer peripheral surface of the upper coating layer formed in the precedent step and vulcanizing the rubber elastic layer forming material by heating to thereby form the rubber elastic layer, wherein the rubber elastic layer and the undercoating layer are adhered through the upper coating layer while heated and vulcanized. In this step, an adhesive layer is formed between the axis body and the rubber elastic layer.

The rubber elastic layer forming material can suitably be prepared according to the applications of a conductive roll to be manufactured. The rubber elastic layer forming material can indeed contain a rubber (including an elastomer, omitted hereinafter) to impart a rubber elasticity to the rubber elastic layer. Specific examples of the rubber include acrylonitrile-butadiene rubber (NBR), Hydrin rubber (ECO, CO, GECO), isoprene rubber (IR), styrene-butadiene rubber (SBR), butadiene rubber (BR), ethylene-propylene-diene rubber (EPDM), urethane rubber (U) and silicone rubber (Q). These can be used singly or in combination. As the rubber, a Hydrin rubber (ECO, CO, GECO) can suitably be used from the viewpoint of easiness of chemical bond to a phenol resin adhesive, an SP value approximate to that of phenol, ionic conductivity, and the like; and an acrylonitrile-butadiene rubber (NBR), from the viewpoint of easiness of chemical bond to a phenol resin adhesive, an SP value approximate to that of phenol, and the like.

In order to impart conductivity to the rubber elastic layer to be formed, there can be added, to the rubber elastic layer-forming material, a conducting agent including: an electron conducting agent such as a carbon-based conductive material, for example, carbon black, carbon nanotubes or graphite, and a conductive metal oxide, for example, barium titanate, c-TiO₂, c-ZnO or c-SnO₂ (c-means conductivity); an ion conducing agent such as a quaternary ammonium salt, a boric acid salt, a perchloric acid salt or an ion liquid; or the like. The rubber elastic layer forming material can additionally contain various types of additives such as a vulcanizing agent, a vulcanization promoter, a plasticizer, a softening agent, a lubricant, a filler, a catalyst and an antioxidant.

Specifically, the rubber elastic layer can be formed in a roll form on the outer peripheral surface of the upper coating layer. A specific example of a method for forming the rubber elastic layer includes a method in which the axis body having the undercoating layer and the upper coating layer is coaxially set in a roll-shaped hollow space in a roll forming mold; the rubber elastic layer forming material is injected therein, heated to be vulcanized, and thereafter cooled and demolded. Other examples includes a method in which the rubber elastic layer forming material is extruded in a roll form on the surface of the axis body having the undercoating layer and the upper coating layer, and heated to be vulcanized. The undercoating layer is firmly adhered to the axis body by baking. Both of the undercoating layer and the upper coating layer are adhesive agents and are compatible with each other. Therefore, this method for manufacturing a conductive roll has also an advantage that the undercoating layer and the upper coating layer hardly flow due to the contact of the rubber elastic layer forming material, and the firm adhesive force between the axis body and the rubber elastic layer is easily secured.

The thickness of the rubber elastic layer can suitably be regulated according to the use of a conductive roll to be manufactured. The thickness of the rubber elastic layer, from the viewpoint of the flexibility and the cost of the roll, and the like, can be made to be, for example, about 0.5 to 10 mm, specifically about 1 to 5 mm, and more specifically about 2 to 4 mm.

In the aforesaid heat vulcanization, from the viewpoint of improvement of the vulcanizing adhesivity of the rubber elastic layer and the undercoating layer, which is effected by the upper coating layer, the improvement of the degree of crosslinking of the rubber elastic layer, and the like, the hot vulcanizing temperature can be made to be, for example, about 120° C. to 200° C., and preferably about 140° C. to 180° C.; and the hot vulcanizing time, for example, about 5 min to 60 min, and preferably about 10 min to 45 min.

Here, a conductive roll obtained by the aforesaid method for manufacturing a conductive roll is usually manufactured in a state that the adhesive interface of the undercoating layer and the upper coating layer is unclear.

The method for manufacturing a conductive roll may include any further steps in addition to the above steps, as required, such as a step of forming a surface layer on the surface of the rubber elastic layer and a step of subjecting the surface of the rubber elastic layer to a surface treatment. The method for manufacturing a conductive roll may further include, for example, a step of forming another rubber elastic layer on the surface of the rubber elastic layer.

Then, the aforesaid constitutions can optionally be combined according to needs to attain the aforesaid functional effects and the like.

### EXAMPLES

Hereinafter, a method for manufacturing a conductive roll and a conductive roll in accordance with examples will be described by way of the drawings. Here, the description will be made by using the same reference signs for the same members.

### Example 1

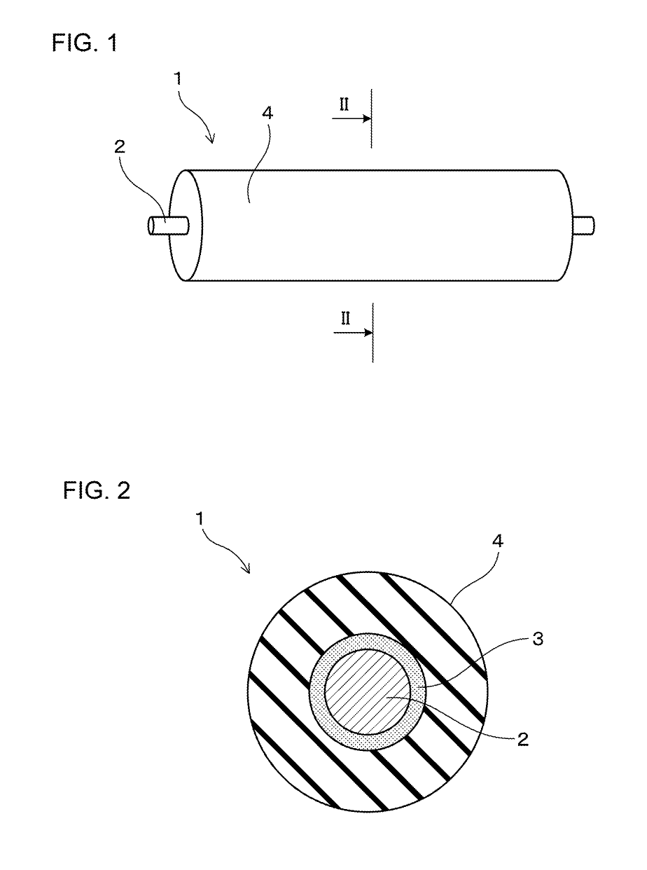

A method for manufacturing a conductive roll of this Example is, as illustrated in FIG. 1 and FIG. 2, a method for manufacturing a conductive roll 1 including an axis body 2 with a surface formed of metal, an adhesive layer 3 formed on the outer peripheral surface of the axis body 2, and a conductive rubber elastic layer 4 formed on the outer peripheral surface of the adhesive layer 3. Here, in FIG. 1, the adhesive layer 3 is omitted. In this Example, the conductive roll 1 is a charging roll to be incorporated in an electrophotographic image forming device.

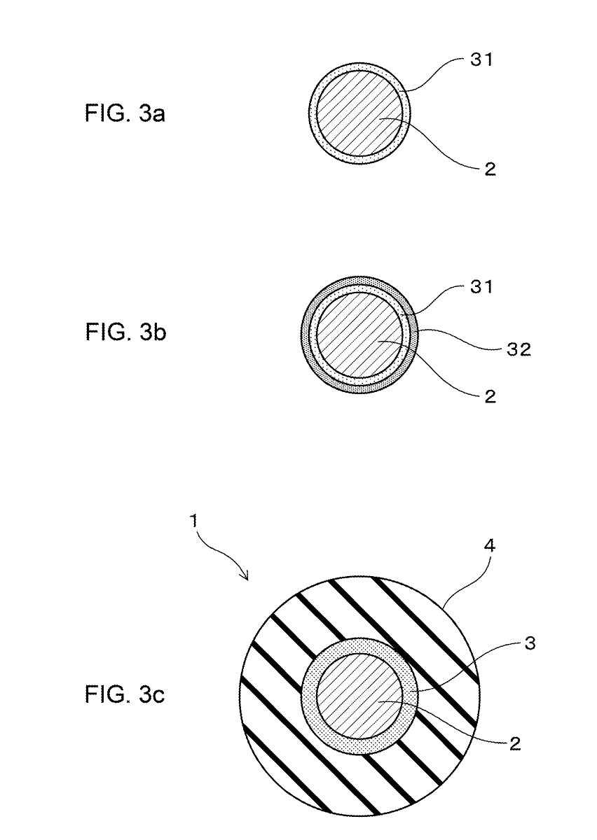

The method for manufacturing a conductive roll of this Example, as illustrated in FIG. 3(a), includes a undercoating layer forming step of applying a phenol resin adhesive to the outer peripheral surface of the axis body 2 and baking the adhesive agent by heating to thereby form a undercoating layer 31. The method, as illustrated in FIG. 3(b), further includes an upper coating layer forming step of further applying a phenol resin adhesive to the outer peripheral surface of the undercoating layer 31 formed in the precedent step to thereby form an upper coating layer 32. The method, as illustrated in FIG. 3(c), further includes a rubber elastic layer forming step of laminating a rubber elastic layer-forming unvulcanized material for forming the rubber elastic layer 4, on the outer peripheral surface of the upper coating layer 32 formed in the precedent step and vulcanizing the rubber elastic layer forming material by heating to thereby form the rubber elastic layer 4, wherein the rubber elastic layer 4 and the undercoating layer 31 are adhered through the upper coating layer 32 while heated and vulcanized.

According to the method for manufacturing a conductive roll of this Example, in the undercoating layer forming step, the phenol resin adhesive is applied to the outer peripheral surface of the axis body 2 and cured by heating to form the undercoating layer 31 firmly adhered to the axis body 2. According to the method for manufacturing a conductive roll of this Example, in the upper coating layer forming step, the uncured upper coating layer 32 is formed on the undercoating layer 31 firmly adhered on the axis body 2. According to the method for manufacturing a conductive roll of this Example, in the rubber elastic layer forming step, the uncured upper coating layer 32 is cured by heat generated during vulcanization of the rubber elastic layer forming material, and adhered to the rubber elastic layer 4 formed by the vulcanization so as to adhere the rubber elastic layer 4 and undercoating layer 31 through the upper coating layer 32 while heated and vulcanized. Further, in the method for manufacturing a conductive roll, because the adhesive layer 3 is composed of the upper coating layer 32 and the undercoating layer 31, the adhesion between the axis body 2 and the adhesive layer 3, and the adhesion of the adhesive layer 3 and the rubber elastic layer 4 can be performed respectively at optimum adhesion temperatures. Consequently, according to the method for manufacturing a conductive roll of this Example, there can be provided a conductive roll 1 improved in adhesion between the axis body 2 and the rubber elastic layer 4.

Further, in the method for manufacturing a conductive roll of this Example, a novolac-type phenol resin adhesive and/or a resol-type phenol resin adhesive are/is used as the phenol resin adhesive. Therefore, in the method for manufacturing a conductive roll of this Example, by regulating the ratio of a novolac-type structure and a resol-type structure, the adhesivity to the surface of the axis body 2 and the adhesivity to the rubber elastic layer 4 are made to be easily regulated within an optimum range, and has an advantage that the conductive roll 1 excellent in adhesion between the axis body 2 and the rubber elastic layer 4 is easily obtained.

Hereinafter, the Examples will be described in detail by using experimental examples.

### (Preparation of Rubber Elastic Layer Forming Materials)

100 parts by mass of a Hydrin rubber (“HydrinT3106,” manufactured by neon Corp.), 1 part by mass of stearic acid (lubricant), 1 part by mass of sulfur (vulcanizing agent), 5 parts by mass of a hydrotalcite compound (acid acceptor)(manufactured by Kyowa Chemical Industry Co., Ltd., “DHT-4A”), 5 parts by mass of zinc oxide (vulcanizing auxiliary agent), 0.3 parts by mass of an antiaging agent (“Nocrac NS-6,” manufactured by Ouchi Shinko Chemical Industrial Co., Ltd.) and 1.0 part by mass of a vulcanizing accelerator (“Nocceler DM,” manufactured by Ouchi Shinko Chemical Industrial Co., Ltd.) were blended, and kneaded using a roll to prepare a rubber elastic layer forming material (1).

100 parts by mass of an acrylonitrile-butadiene rubber (NBR)(“DN219,” manufactured by Zeon Corp.), 1 part by mass of stearic acid (lubricant), 1 part by mass of sulfur (vulcanizing agent), 5 parts by mass of zinc oxide (vulcanizing auxiliary agent), 0.3 parts by mass of an antiaging agent (“Nocrac NS-6,” manufactured by Ouchi Shinko Chemical Industrial Co., Ltd.), 1.0 part by mass of a vulcanizing accelerator (“Nocceler DM,” manufactured by Ouchi Shinko Chemical Industrial Co., Ltd.) and 0.5 parts by mass of a vulcanizing accelerator (“Nocceler TRA,” manufactured by Ouchi Shinko Chemical Industrial Co., Ltd.) were blended, and kneaded using a roll to prepare a rubber elastic layer forming material (2).

### (Fabrication of Conductive Roll Samples)

A phenol resin adhesive (manufactured by Toyokagaku Kenkyusho Co., Ltd., “Metaloc UB”) was sprayed on the outer peripheral surface of a core metal of 8 mm in diameter, dried at normal temperature, and thereafter, baked at each heating temperature for each heating time indicated in Table 1 and Table 2 to form each undercoating layer having a thickness indicated in Table 1 and Table 2. Here, in place of the aforesaid adhesive agent, “Chemlok 205,” manufactured by Lord Far East Inc., or the like may be used.

Then, the same phenol resin adhesive as mentioned above was further applied to the outer peripheral surface of each undercoating layer to form upper coating layer each having a thickness indicated in Table 1 and Table 2.

Then, a roll forming mold having a roll-shaped hollow space was prepared, and the core metal having the predetermined undercoating layer and upper coating layer was set so as to be coaxial with the hollow space. One of the rubber elastic layer forming material (1) and the rubber elastic layer forming material (2) was injected in the hollow space containing the core metal set therein as shown in Table 1 and Table 2, and heated at 180° C. for 30 min for vulcanization. Each rubber elastic layer (thickness: 2 mm) is formed by the vulcanization, and during the vulcanization, each rubber elastic layer and each undercoating layer were adhered through each upper coating layer. Thereafter, the resultant was cooled and demolded. There were thereby obtained conductive rolls of samples 1 to 16, each having a core metal as an axis body, an adhesive layer formed on the outer peripheral surface of the core metal, and a rubber elastic layer with conductivity formed on the outer peripheral surface of the adhesive layer. Here, the aforesaid adhesive layer is composed of the undercoating layer and the upper coating layer, and was in the state that the boundary between the undercoating layer and the upper coating layer could not be observed.

For comparison, conductive rolls of samples 17 to 23 were prepared in the same manner as in the fabrication of the conductive rolls of the samples 1 to 16, except for forming no upper coating layer.

Further a conductive roll of a sample 24 was prepared in the same manner as in the fabrication of the conductive rolls of the samples 1 to 16, except for excluding the aforesaid baking in the undercoating layer forming step.

### (An Upper Coating Layer Remained Uncured).

### (Evaluation of Adhesivity)

Adhesivity in each conductive roll sample was evaluated by applying a force for forcibly peeling off a rubber elastic layer from a core metal. The case where failure occurred in the rubber elastic layer when the rubber elastic layer was peeled off, was taken as being excellent in adhesion between the core metal and the rubber elastic layer and being improved in adhesivity, and classed as “A.” By contrast, the case where no failure occurred in the rubber elastic layer but failure occurred between the core metal and an adhesive layer, or between the adhesive layer and the rubber elastic layer when the rubber elastic layer was peeled off, was taken as being poor in adhesion between the core metal and the rubber elastic layer and not being improved in adhesivity, and classed as “C.”

The detailed manufacturing condition of the conductive roll samples and the results of the adhesivity evaluation are collectively shown in Table 1 and Table 2.

TABLE 1

| | Samples | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Choice of rubber elastic | (1) | (1) | (1) | (1) | (1) | (1) | (1) | (1) | (2) | (2) | (2) | (2) |
| layer-forming material | | | | | | | | | | | | |
| Undercoating layer | | | | | | | | | | | | |
| Heating temperature (° C.) | 180 | 220 | 140 | 180 | 180 | 180 | 180 | 180 | 180 | 220 | 140 | 180 |
| Heating time (minutes) | 10 | 10 | 10 | 1 | 30 | 10 | 10 | 10 | 10 | 10 | 10 | 1 |
| Thickness (μm) | 3 | 3 | 3 | 3 | 3 | 0.1 | 3 | 0.1 | 3 | 3 | 3 | 3 |
| Upper coating layer | | | | | | | | | | | | |
| Thickness (μm) | 3 | 3 | 3 | 3 | 3 | 3 | 0.1 | 0.1 | 3 | 3 | 3 | 3 |
| Thickness of adhesive layer (μm) | 6 | 6 | 6 | 6 | 6 | 3.1 | 3.1 | 0.2 | 6 | 6 | 6 | 6 |
| Evaluation of adhesivity | A | A | A | A | A | A | A | A | A | A | A | A |

TABLE 2

| | Samples | | | | | | | | | | | |
|---|---|---|---|---|---|---|---|---|---|---|---|---|
| | 13 | 14 | 15 | 16 | 17 | 18 | 19 | 20 | 21 | 22 | 23 | 24 |
| Choice of rubber elastic | (2) | (2) | (2) | (2) | (1) | (1) | (1) | (1) | (1) | (1) | (1) | (1) |
| layer-forming material | | | | | | | | | | | | |
| Undercoating layer | | | | | | | | | | | | |
| Heating temperature (° C.) | 180 | 180 | 180 | 180 | 180 | 185 | 175 | 180 | 180 | 180 | 180 | — |
| Heating temperature (° C.) | 30 | 10 | 10 | 10 | 10 | 10 | 10 | 5 | 15 | 10 | 10 | |
| Thickness (μm) | 3 | 0.1 | 3 | 0.1 | 3 | 3 | 3 | 3 | 3 | 2 | 4 | 3 |
| Upper coating layer | | | | | | | | | | | | |
| Thickness (μm) | 3 | 3 | 0.1 | 0.1 | — | — | — | — | — | — | — | 3 |
| Thickness of adhesive layer (μm) | 6 | 3.1 | 3.1 | 0.2 | 3 | 3 | 3 | 3 | 3 | 2 | 4 | 6 |
| Evaluation of adhesivity | A | A | A | A | C | C | C | C | C | C | C | C |

Table 1 and Table 2 show the following. Specifically, in fabrication of the conductive rolls of the sample 17 to the sample 23, a phenol resin adhesive applied to a core metal is baked, and thereafter a rubber elastic layer is formed without a phenol resin adhesive further applied. Therefore, the adhesivity between the core metal and the rubber elastic layer is poor.

In fabrication of the conductive roll of the sample 24, a phenol resin adhesive is further applied without baking the phenol resin adhesive applied to a core metal, and thereafter a rubber elastic layer is formed. Therefore, the adhesivity between the core metal and the adhesive agent is poor.

By contrast, the conductive rolls of the sample 1 to the sample 16 were fabricated through a undercoating layer forming step, an upper coating layer forming step and a rubber elastic layer forming step prescribed in the present invention. Therefore, each conductive roll thus obtained has such a high adhesive force that when a force for forcibly peeling off a rubber elastic layer from a core metal is applied for evaluation of adhesivity, no peeling-off occurred either between the core metal and the adhesive layer, or between the adhesive layer and the rubber elastic layer, but failure occurred in the rubber elastic layer. It was confirmed from this result that according to the method for manufacturing a conductive roll prescribed in the present invention, a conductive roll improved in adhesion between the axis body and the rubber elastic layer can be obtained.

Hitherto, the Examples of the present invention have been described in detail, but the present invention is not limited to the above Examples, and various changes may be made within the range of not impairing the gist of the present invention.

1. A method for manufacturing a conductive roll for use in an electrophotographic image forming device, which comprises an axis body with a surface formed of metal, an adhesive layer formed on an outer peripheral surface of the axis body, and a rubber elastic layer with conductivity formed on an outer peripheral surface of the adhesive layer, the method comprising:
an undercoating layer forming step of applying a phenol resin adhesive to the outer peripheral surface of the axis body and baking the phenol resin adhesive by heating to thereby form an undercoating layer;
an upper coating layer forming step of further applying the phenol resin adhesive to an outer peripheral surface of the undercoating layer formed in the precedent step to thereby form an upper coating layer; and
a rubber elastic layer forming step of laminating a rubber elastic layer-forming unvulcanized material for forming the rubber elastic layer, on an outer peripheral surface of the upper coating layer formed in the precedent step and vulcanizing the rubber elastic layer-forming material by heating to thereby form the rubber elastic layer, wherein the rubber elastic layer and the undercoating layer are adhered through the upper coating layer while heated and vulcanized.

2. The method for manufacturing a conductive roll according to claim 1,
wherein the phenol resin adhesive comprises at least one of a novolac-type phenol resin adhesive and a resol-type phenol resin adhesive.

3. The method for manufacturing a conductive roll according to claim 1,
wherein the phenol resin adhesive comprises a liquid composition comprising at least one of monomer component and oligomer component to form a novolac-type phenol resin and/or a resol-type phenol resin, and an organic solvent.

4. The method for manufacturing a conductive roll according to claim 2,
wherein the phenol resin adhesive comprises a liquid composition comprising at least one of monomer component and oligomer component to form a novolac-type phenol resin and/or a resol-type phenol resin, and an organic solvent.

5. The method for manufacturing a conductive roll according to claim 1,
wherein a thickness of the undercoating layer is in the range of 0.1 μm to 10 μm and/or a thickness of the upper coating layer is in the range of 0.1 μm to 10 μm.

6. The method for manufacturing a conductive roll according to claim 4,
wherein a thickness of the undercoating layer is in the range of 0.1 μm to 10 μm and/or a thickness of the upper coating layer is in the range of 0.1 μm to 10 μm.

7. The method for manufacturing a conductive roll according to claim 1,
wherein a thickness of the undercoating layer is in the range of 1 μm to 5 μm.

8. The method for manufacturing a conductive roll according to claim 6,
wherein a thickness of the undercoating layer is in the range of 1 μm to 5 μm.

9. The method for manufacturing a conductive roll according to claim 1,
wherein a thickness of the upper coating layer is in the range of 1 μm to 7 μm.

10. The method for manufacturing a conductive roll according to claim 8,
wherein a thickness of the upper coating layer is in the range of 1 μm to 7 μm.

11. The method for manufacturing a conductive roll according to claim 1,
wherein the rubber elastic layer forming material comprises at least one of acrylonitrile-butadiene rubber and Hydrin rubber.

12. The method for manufacturing a conductive roll according to claim 10,
wherein the rubber elastic layer forming material comprises at least one of acrylonitrile-butadiene rubber and Hydrin rubber.

13. The method for manufacturing a conductive roll according to claim 1,
wherein a heating temperature for baking the phenol resin adhesive in the undercoating layer forming step is in the range of 140° C. to 220° C.

14. The method for manufacturing a conductive roll according to claim 12,
wherein a heating temperature for baking the phenol resin adhesive in the undercoating layer forming step is in the range of 140° C. to 220° C.

15. The method for manufacturing a conductive roll according to claim 1,
wherein a thickness of the rubber elastic layer is in the range of 0.5 to 10 mm.

16. The method for manufacturing a conductive roll according to claim 14,
wherein a thickness of the rubber elastic layer is in the range of 0.5 to 10 mm.

17. A conductive roll obtained by the method for manufacturing a conductive roll according to claim 1.

18. A conductive roll obtained by the method for manufacturing a conductive roll according to claim 10.

19. A conductive roll obtained by the method for manufacturing a conductive roll according to claim 14.

20. A conductive roll obtained by the method for manufacturing a conductive roll according to claim 16.
